(19) United States
(12) Patent Application Publication
(10) Pub. No.: US 2004/0126743 A1
(43) Pub. Date: Jul. 1, 2004

(54) Child's dental crown

(76) Inventors: Thomas J. Mayclin, St. Louis Park, MN (US); Trustee Thomas Mayclin, St. Louis Park, MN (US)

Correspondence Address: JOHN W. ADAMS, SUITE 418, 401 SECOND AVENUE SOUTH, MINNEAPOLIS, MN, 55401-2304, US

(21) Appl. No.: 10/331,968

(22) Filed: Dec. 30, 2002

(51) Int. Cl. A61C 5/08

(52) U.S. Cl. 433/218

(57) ABSTRACT

This invention provides an inexpensive crown construction which is particularly adapted for use with the “baby” teeth of children and which is particularly intended to provide mechancial attachment means for the overlying esthetic layer of the inventive crown construction.

This is a dental crown which is particularly constructed to provide an inexpensive crown unit adapted for use with children which provides a stainless steel portion which surrounds the tooth and which has an imperforate cover layer which surrounds the cap member.

### BACKGROUND OF THE INVENTION

In the past it has been a problem for dentists to provide an inexpensive crown particularly adapted for use with children's cavities in their “baby” teeth and to produce a construction which will provide a suitable enclosure for a “baby” tooth which has developed a cavity.

### DESCRIPTION OF THE DRAWINGS

FIG. 1 is a sectional view of a crown embodying the invention, and;

FIG. 2 is a top plan view of the crown shown in FIG. 1.

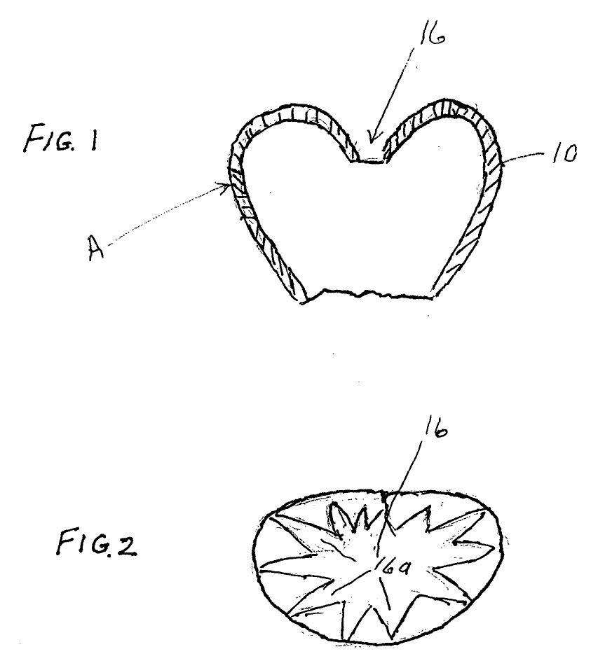

### DETAILED DESCRIPTION OF THE INVENTION

The enclosed drawings illustrate a typical tooth 10 which will receive an overlying crown assembly designated as an entirety by the letter A.

The tooth-enclosing crown construction includes a base element 14 which is cemented to the tooth and which is provided with an opening 16 which receives an esthetic composite material and provides a biting surface for a crown.

This opening 16 has a plurality of teeth 16a around the periphery thereof which produce a serrated periphery around the opening 16.

The serrated edge portions of the opening mechanically increase the griping power of the base and ensure positive attachment of the overlying esthetic layer of the crown assembly.

What is claimed is:

1. A dental crown comprising a stainless steel base member adapted to be installed on a tooth to enclose same and covering the biting surface of the tooth,
the biting area of the crown having a plurality of openings formed therein to permit the outer cosmetic covering material to penetrate into the hollow cavity portion of the crown to secure the covering material to the outer surface of the cap member and cover the biting area of the tooth to be capped,
and an imperforate cover portion overlying the crown of the tooth and securable to the body of the tooth.

2. The structure set forth in claim 1 and the biting area of the crown being indented and wherein the openings form a plurality of inwardly curved attachment fingers to receive the material of the cover portion and increase the thickness thereof and provide a durable biting surface for the tooth.
